(19) United States
(12) Patent Application Publication
(10) Pub. No.: US 2018/0299268 A1
(43) Pub. Date: Oct. 18, 2018

(54) Sensor Boosting Technique

(71) Applicant: Google LLC, Mountain View, CA (US)

(72) Inventors: Greg Klein, Mountain View, CA (US); Daniel Aden, Mountain View, CA (US); Arshan Poursohi, Mountain View, CA (US)

(21) Appl. No.: 14/628,100

(22) Filed: Feb. 20, 2015

(51) Int. Cl. G01B 21/16

(52) U.S. Cl. CPC G01B 21/16

(57) ABSTRACT

Implementations disclosed herein may include a system and method for engaging in a technique for calibrating and/or boosting the accuracy of an arrangement of sensors positioned about a physical space. In one implementation, a method includes receiving from a primary sensor an indication of a particular location of a subject and receiving a first feature from a plurality of secondary sensors. The first feature may comprise a set of estimated locations of the subject. The method may further include resolving the first feature as being indicative of the particular location, receiving a second feature from the plurality of secondary sensors, identifying a match between the second feature and the first feature, and based on the identifying, determining a location of the new subject to be the particular location.

### BACKGROUND

Physical spaces may be used for retail, manufacturing, assembly, distribution, and office spaces, among others. Over time, the manner in which these physical spaces are designed and operated is becoming more intelligent, more efficient, and more intuitive. As technology becomes increasingly prevalent in numerous aspects of modern life, the use of technology to enhance these physical spaces becomes apparent. Therefore, a demand for such systems has helped open up a field of innovation in sensing techniques, data processing, as well as software and user interface design.

### SUMMARY

Example implementations of the present disclosure may relate to a machine learning technique for calibrating and/or boosting the accuracy of an arrangement of sensors positioned about a physical space. The arrangement of sensors may include at least one primary sensor that tends to produce a relatively accurate indication of where in the physical space a given subject is located, such as a sophisticated motion-capture (Mo-cap) sensor, or a Velodyne LiDAR sensor. The arrangement of sensors may also include a plurality of secondary sensors that tend to produce relatively inaccurate indications of where a given subject is located, such as general inexpensive motion sensors, sound sensors, pressure sensors, and temperature sensors, among others.

In one aspect, a method is provided. The method may include receiving from a primary sensor an indication of a particular location of a subject and receiving a first feature from a plurality of secondary sensors. The first feature may comprise a set of estimated locations of the subject. The method may further include resolving the first feature as being indicative of the particular location, receiving a second feature from the plurality of secondary sensors, identifying a match between the second feature and the first feature, and based on the identifying, determining a location of the new subject to be the particular location.

In another aspect, a second method is provided. The second method may include receiving from a primary sensor an indication of a particular location of a subject and for each given secondary sensor of a plurality of secondary sensors receiving from the given secondary sensor an estimated location of the subject, and assigning a confidence level to the given secondary sensor for the estimated location. The method may further include receiving from the plurality of secondary sensors conflicting indications of estimated locations of a new subject, identifying confidence levels assigned to the plurality of secondary sensors for the respective estimated locations of the new subject, and based on the identified confidence levels and the estimated locations of the new subject, determining a location of the new subject.

In yet another aspect, a system is provided. The system may include a plurality of sensors including a primary sensors and a plurality of secondary sensors, one or more processors, a communication interface, and computer-readable storage media having stored thereon instructions that, when executed by the one or more processors, cause the system to engage in operations. The operations may include receiving from a primary sensor an indication of a particular location of a subject and for each given secondary sensor of a plurality of secondary sensors receiving from the given secondary sensor an estimated location of the subject, and assigning a confidence level to the given secondary sensor for the estimated location. The operations may further include receiving from the plurality of secondary sensors conflicting indications of estimated locations of a new subject, identifying confidence levels assigned to the plurality of secondary sensors for the respective estimated locations of the new subject, and based on the identified confidence levels and the estimated locations of the new subject, determining a location of the new subject.

These as well as other aspects, advantages, and alternatives will become apparent to those of ordinary skill in the art by reading the following detailed description, with reference where appropriate to the accompanying drawings.

### BRIEF DESCRIPTION OF THE DRAWINGS

FIG. 1 depicts an example configuration of a system for engaging in a sensor boosting technique, in accordance with an example implementation.

FIG. 2 depicts an example physical space, in accordance with an example implementation.

FIG. 3 depicts an example flowchart, in accordance with an example implementation.

FIG. 4 depicts an example representation of a physical space, in accordance with an example implementation.

FIG. 5 depicts another example representation of a physical space, in accordance with an example implementation.

FIG. 6 depicts an example heat map, in accordance with an example implementation.

FIG. 7 depicts an example flowchart, in accordance with an example implementation.

### DETAILED DESCRIPTION

In the following detailed description, reference is made to the accompanying figures, which form a part hereof. In the figures, similar symbols typically identify similar components, unless context dictates otherwise. The illustrative implementations described in the detailed description, figures, and claims are not meant to be limiting. Other implementations may be utilized, and other changes may be made, without departing from the scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

### I. Overview

Example implementations of the present disclosure relate to a technique for calibrating and/or boosting the accuracy of an arrangement of sensors positioned about a physical space. The arrangement of sensors may include at least one primary sensor that tends to produce a relatively accurate indication of where in the physical space a given subject is located, such as a sophisticated motion-capture (Mo-cap) sensor, or a Velodyne LiDAR sensor. The arrangement of sensors may also include a plurality of secondary sensors that tend to produce relatively inaccurate indications of where a given subject is located, such as general inexpensive motion sensors, sound sensors, pressure sensors, and temperature sensors, among others.

Example implementations of the present disclosure may be advantageous in situations in which the primary sensor is available for limited periods of time. For example, some primary sensors are expensive. Thus, a primary sensor may be provisioned in a physical space for just a limited period of time, perhaps during an initial calibration phase of the physical space. Thereafter, the primary sensor may be moved to another physical space to assist in the calibration phase of that physical space. Additionally, some primary sensors consume significant processing resources, and as a result, it may be impractical to utilize such primary sensors for long periods of time. Thus, some example implementations described herein involve engaging in the sensor boosting and calibration functionality with respect to a primary sensor and a secondary sensor, after which the primary sensor is removed and the remainder of the functionality is carried out with respect to just the secondary sensor(s). Other implementations are also possible, in which, for instance, the primary sensor is not removed and is instead intermittently powered down, used in a different operating mode (such as a low-power mode), and/or remains fully functional.

In accordance with one example implementation of the technique, when a given subject is located in the environment, a computing system receives a particular pattern of outputs from the secondary sensors and resolves that pattern as being indicative of a particular location of the subject based on the output of the primary sensor. To do this, the computing system first receives from the primary sensor an indication of a given subject's location. For example, the primary sensor may indicate that the given subject is located in location A. The server system next receives from the secondary sensors a pattern of outputs indicative of one or more estimated locations of the given subject. For example, of three secondary sensors, secondary sensor 1's output may indicate that the subject is located in location A, secondary sensor 2's output may indicate that the subject is located in location B, and second sensor 3's output may indicate that the subject is located in location A. As a result, the computing system may resolve this particular pattern of secondary sensor outputs as being indicative of a subject being located in location A (which is the location indicated by the primary sensor). The computing system may repeat this technique for a plurality of different locations of the subject (or other subjects) in order to build a set of secondary sensor output patterns, each matched to a particular location. Thus, when the primary sensor is removed, the server system may still accurately locate a subject by determining a given pattern of secondary sensor outputs and matching it to a particular location from the set of matched patterns.

In accordance with another implementation of the technique, the computing system compares the output of a single secondary sensor with the output of the primary sensor for a plurality of locations of a given subject. For each location, the computing system assigns a confidence level rating (e.g., on a percentage scale from 0% to 100%) to the secondary sensor based on how close the secondary sensor indicates the given subject is to the location of the subject indicated by the primary sensor. The server system may repeat this for each secondary sensor in order to build a set of confidence levels at each location and for each secondary sensor. Thus, when the primary sensor is removed, the server system may resolve a conflict between sensor outputs by referring to each sensor's confidence level and determining the location of a subject based on a comparison between the conflicting sensors' assigned confidence levels. In one example of this, the computing system determines the subject's location to be the location indicated by the sensor having the highest confidence level. For instance, if sensor 1 indicates that a subject is located in location A, which for sensor 1 has a confidence level of, say, 80%; sensor 2 indicates that the subject is located in location B, which for sensor 2 has a confidence level of, say, 60%; and sensor 3 indicates that the subject is located in location C, which for sensor 3 has a confidence level of, say, 60%; the computing system may determine that the subject is located in location A because that location is associated with the highest confidence level of any of the sensors.

### II. Example Systems

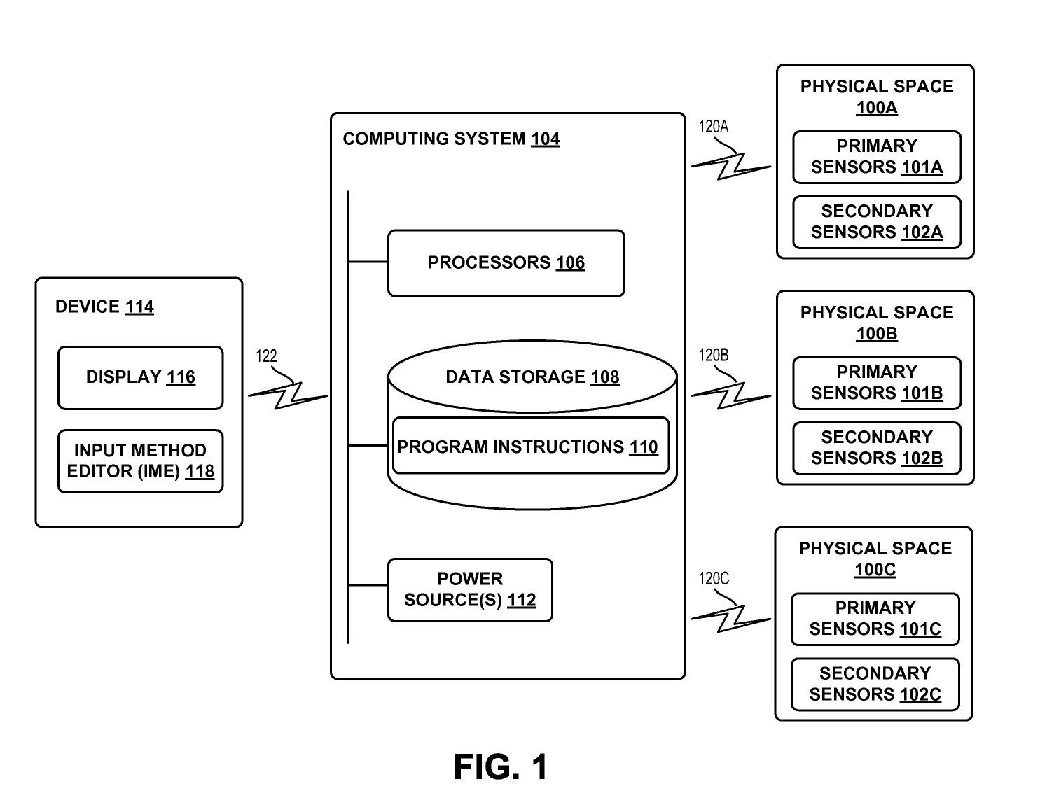

Referring now to the figures, FIG. 1 shows an example arrangement including one or more physical spaces 100A-100C each having one or more primary sensors 101A-101C and one or more secondary sensors 102A-102C, respectively. A physical space may define a portion of an environment in which people, objects, and/or machines may be located. The physical space may take on a two-dimensional or a three-dimensional form and may be used for various purposes. For instance, the physical space may be used as a retail space where the sale of goods and/or services is carried out between individuals (or businesses) and consumers. While various aspects of the disclosure are discussed below in the context of a retail space, example implementations are not limited to retail spaces and may extend to a variety of other physical spaces such as manufacturing facilities, distribution facilities, office spaces, shopping centers, festival grounds, and/or airports, among other examples. Additionally, while three physical spaces 100A-100C are shown in FIG. 1, example implementations may be carried out in the context of a single physical space or a plurality of physical spaces.

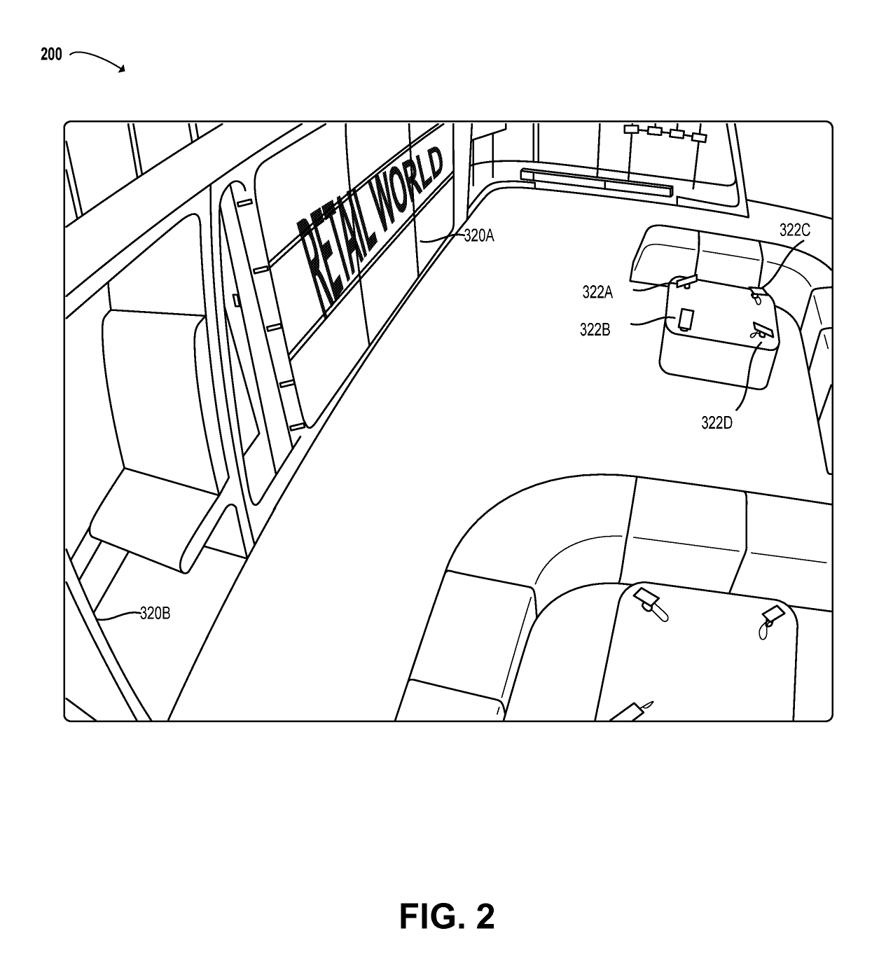

For context purposes, FIG. 2 depicts an example physical space 200, embodied as a “Retail World” retail location. Physical space 200 may have a variety objects positioned throughout the physical space, such as displays 320A and 320B (not visible) as well as devices 322A-322D, among others. Primary and secondary sensors (not shown) may be positioned throughout the physical space to facilitate the collection of certain information, such as the location and movement of objects and actors throughout the physical space. This type of information may be provided to managers of the physical space to help these managers make decisions about how to improve or maintain the physical space, or for other reasons.

As mentioned, each physical space may include one or more primary sensors 101A-101-C and one or more secondary sensors 102A-102C. In some examples, the primary sensor(s) 101A-101C may be temporarily provided within the physical spaces (e.g., at the set-up phase of a new physical space) in order to engage in the calibration and sensor boosting techniques described herein. Accordingly, the primary sensor(s) 101A-101C may be relatively more sophisticated (and in some cases, relatively more expensive) than the secondary sensors 102A-102C. Example primary sensors 101A-101C may include but are not limited to certain motion-capture (Mocap) sensors or Velodyne LiDAR sensors, among others. Example secondary sensors 102A-102C may include but are not limited to generic force sensors, proximity sensors, motion sensors (e.g., an inertial measurement units (IMU), gyroscopes, and/or accelerometers), load sensors, position sensors, thermal imaging sensors, facial recognition sensors, depth sensors (e.g., RGB-D, laser, structured-light, and/or a time-of-flight camera), point cloud sensors, ultrasonic range sensors, infrared sensors, Global Positioning System (GPS) receivers, sonar, optical sensors, biosensors, Radio Frequency identification (RFID) systems, Near Field Communication (NFC) chip, wireless sensors, compasses, smoke sensors, light sensors, radio sensors, microphones, speakers, radars, touch sensors (e.g., capacitive sensors), cameras (e.g., color cameras, grayscale cameras, and/or infrared cameras), and/or range sensors (e.g., ultrasonic and/or infrared), among others.

Additionally, the primary and secondary sensors may be positioned within or in the vicinity of the physical space, among other possible locations. Further, an example implementation may also use sensors incorporated within existing devices such as mobile phones, laptops, and/or tablets. These devices may be in possession of people located in the physical space such as consumers and/or employees within a retail space. Additionally or alternatively, these devices may be items on display such as in a retail space used for sale of consumer electronics, for example. Yet further, each of physical spaces 100A-100C may include the same combination of sensors or may each include different combinations of sensors.

FIG. 1 also depicts a computing system 104 that may receive data from the sensors 102A-102C positioned in the physical spaces 100A-100C. In particular, the sensors 102A-102C may provide sensor data to computing system by way of communication links 120A-120C, respectively. Communication links 120A-120C may include wired links and/or wireless links (e.g., using various wireless transmitters and receivers). A wired link may include, for example, a parallel bus or a serial bus such as a Universal Serial Bus (USB). A wireless link may include, for example, Bluetooth, IEEE 802.11(IEEE 802.11 may refer to IEEE 802.11-2007, IEEE 802.11n-2009, or any other IEEE 802.11 revision), Cellular (such as GSM, GPRS, CDMA, UMTS, EV-DO, WiMAX, HSPDA, or LTE), or Zigbee, among other possibilities. Furthermore, multiple wired and/or wireless protocols may be used, such as “3G” or “4G” data connectivity using a cellular communication protocol (e.g., CDMA, GSM, or WiMAX, as well as for “Wi-Fi” connectivity using 802.11).

In other examples, the arrangement may include access points through which the sensors 101A-101C and 102A-102C and/or computing system 104 may communicate with a cloud server. Access points may take various forms such as the form of a wireless access point (WAP) or wireless router. Further, if a connection is made using a cellular air-interface protocol, such as a CDMA or GSM protocol, an access point may be a base station in a cellular network that provides Internet connectivity by way of the cellular network. Other examples are also possible.

Computing system 104 is shown to include one or more processors 106, data storage 108, program instructions 110, and power source(s) 112. Note that the computing system 104 is shown for illustration purposes only as computing system 104 may include additional components and/or have one or more components removed without departing from the scope of the disclosure. Further, note that the various components of computing system 104 may be arranged and connected in any manner.

Each processor, from the one or more processors 106, may be a general-purpose processor or a special purpose processor (e.g., digital signal processors, application specific integrated circuits, etc.). The processors 106 can be configured to execute computer-readable program instructions 110 that are stored in the data storage 108 and are executable to provide the functionality of the computing system 104 described herein. For instance, the program instructions 110 may be executable to provide for processing of sensor data received from sensors 101A-101C and 102A-102C.

The data storage 108 may include or take the form of one or more computer-readable storage media that can be read or accessed by the one or more processors 106. The one or more computer-readable storage media can include volatile and/or non-volatile storage components, such as optical, magnetic, organic or other memory or disc storage, which can be integrated in whole or in part with the one or more processors 106. In some implementations, the data storage 108 can be implemented using a single physical device (e.g., one optical, magnetic, organic or other memory or disc storage unit), while in other implementations, the data storage 108 can be implemented using two or more physical devices. Further, in addition to the computer-readable program instructions 110, the data storage 108 may include additional data such as diagnostic data, among other possibilities. Further, the computing system 104 may also include one or more power source(s) 112 configured to supply power to various components of the computing system 104. Any type of power source may be used such as, for example, a battery.

FIG. 1 further depicts a device 114 that is shown to include a display 116 and an Input Method Editor (IME) 118. The device 114 may take the form of a desktop computer, a laptop, a tablet, a wearable computing device, and/or a mobile phone, among other possibilities. Note that the device 114 is shown for illustration purposes only as device 114 may include additional components and/or have one or more components removed without departing from the scope of the disclosure. Additional components may include processors, data storage, program instructions, and/or power sources, among others (e.g., all (or some) of which may take the same or similar form to components of computing system 104). Further, note that the various components of device 114 may be arranged and connected in any manner.

In some cases, an example arrangement may not include a separate device 114. That is, various features/components of device 114 and various features/components of computing system 104 can be incorporated within a single system. However, in the arrangement shown in FIG. 1, device 114 may receive data from and/or transmit data to computing system 104 by way of communication link 122. Communication link 122 may take on the same or a similar form to communication links 120A-120C as described above.

Display 116 may take on any form and may be arranged to project images and/or graphics to a user of device 114. In an example arrangement, a projector within device 114 may be configured to project various projections of images and/or graphics onto a surface of a display 116. The display 116 may include: an opaque or a transparent (or semi-transparent) matrix display, such as an electroluminescent display or a liquid crystal display, one or more waveguides for delivering an image to the user's eyes, or other optical elements capable of delivering an image to the user. A corresponding display driver may be disposed within the device 114 for driving such a matrix display. Other arrangements may also be possible for display 116. As such, display 116 may show a graphical user interface (GUI) that may provide an application through which the user may interact with the systems disclosed herein.

Additionally, the device 114 may receive user-input (e.g., from the user of the device 114) by way of IME 118. In particular, the IME 118 may allow for interaction with the GUI such as for scrolling, providing text, and/or selecting various features of the application, among other possible interactions. The IME 118 may take on various forms. In one example, the IME 118 may be a pointing device such as a computing mouse used for control of the GUI. However, if display 116 is a touch screen display, touch-input can be received (e.g., such as using a finger or a stylus) that allows for control of the GUI. In another example, IME 118 may be a text IME such as a keyboard that provides for selection of numbers, characters and/or symbols to be displayed by way of the GUI. For instance, in the arrangement where display 116 is a touch screen display, portions the display 116 may show the IME 118. Thus, touch-input on the portion of the display 116 including the IME 118 may result in user-input such as selection of specific numbers, characters, and/or symbols to be shown on the GUI by way of display 116. In yet another example, the IME 118 may be a voice IME that receives audio input, such as from a user by way of a microphone of the device 114, that is then interpretable using one of various speech recognition techniques into one or more characters than may be shown by way of display 116. Other examples may also be possible.

### III. Example Sensor Boosting Techniques

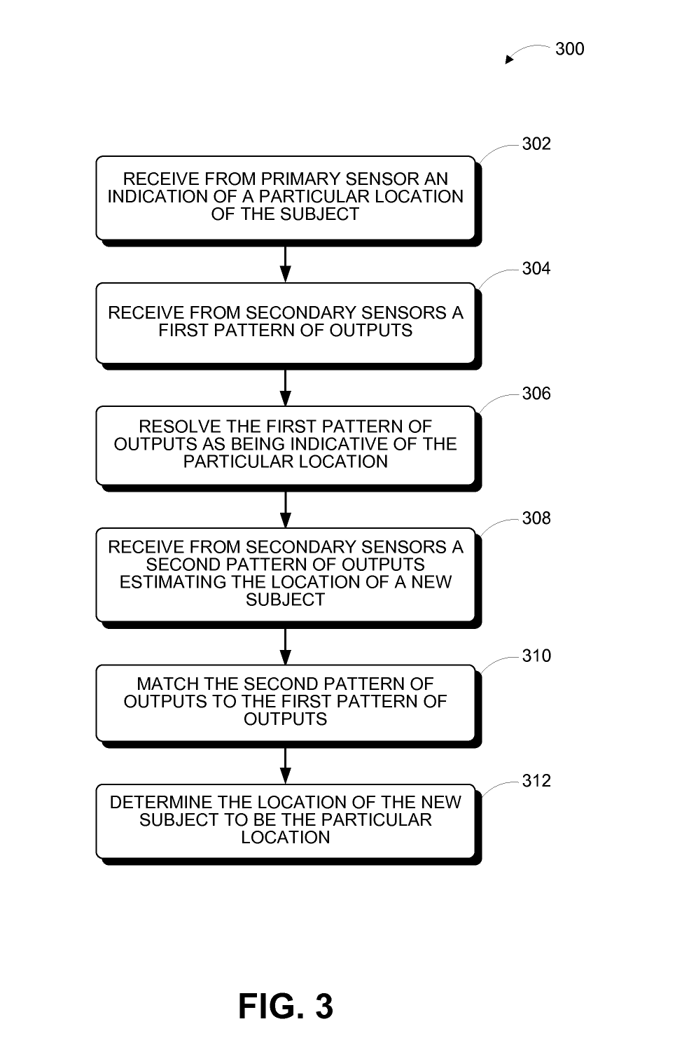

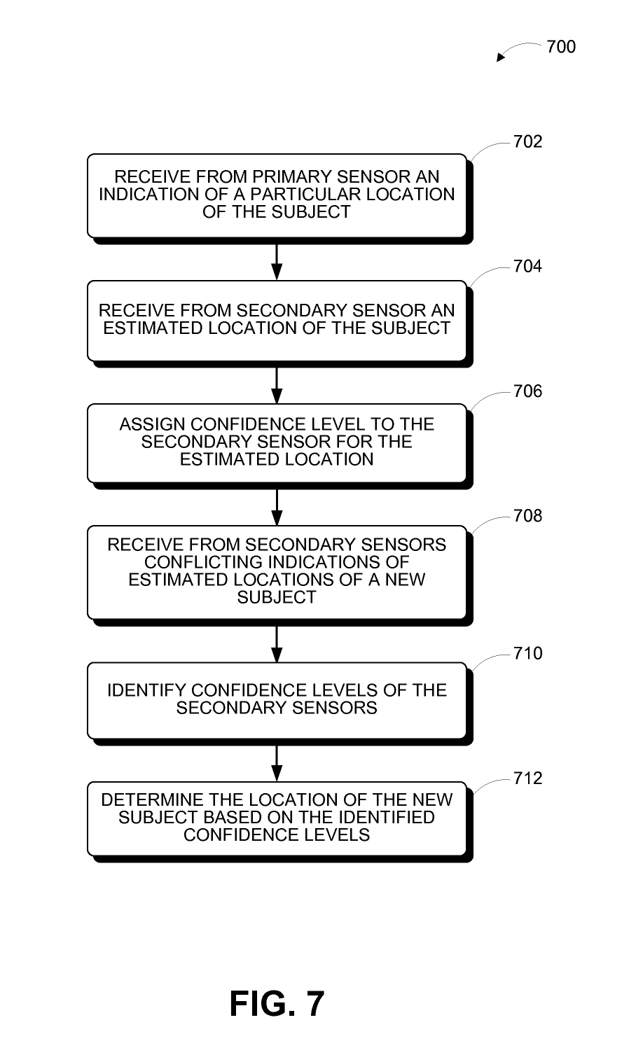

FIGS. 3 and 7 are flowcharts of example methods 300 and 700 that may help calibrate and/or boost the accuracy of sensors in a physical space. The example methods 300 and 700 may include one or more operations, functions, or actions, as depicted by one or more of blocks 302, 304, 306, 308, 310, 312, 702, 704, 706, 708, 710, and/or 712, each of which may be carried out by any of the systems described by way of FIGS. 1 and 2; however, other configurations could be used.

Furthermore, those skilled in the art will understand that the flowcharts described herein illustrate functionality and operation of certain implementations of the present disclosure. In this regard, each block of each flow diagram may represent a module, a segment, or a portion of program code, which includes one or more instructions executable by a processor (e.g., the one or more processors 106) for implementing specific logical functions or steps in the process. The program code may be stored on any type of computer readable medium, for example, such as a storage device including a disk or hard drive (e.g., data storage 108). In addition, each block may represent circuitry that is wired to perform the specific logical functions in the process. Alternative implementations are included within the scope of the example implementations of the present application in which functions may be executed out of order from that shown or discussed, including substantially concurrent or in reverse order, depending on the functionality involved, as would be understood by those reasonably skilled in the art.

Turning first to FIG. 3, method 300 includes receiving from a primary sensor (e.g., sensors 101A) positioned in a physical space (e.g., physical space 100A) an indication of a particular location of a subject. In the context of this application, a subject is any object located in the physical space that is able to be detected by a sensor. In some implementations, a subject is an inanimate object, such as a computing device, an article of merchandise, or piece of machinery located in the physical space, among other examples. However, in other implementations, a subject is an animate object, such as a human being, animal, or robotic device that is able to move about the physical space, among other examples.

In some examples, the indication of the particular location of the subject is received by a computing system (e.g., computing system 104) and in the form of computer-readable data packets specifying coordinates of the particular location. In some examples, these coordinates may be framed from an arbitrary point of reference, such as the center of the physical space or one corner of the physical space. In other examples, the particular location may be in the form of an address, and/or a list of characters representing a name (e.g., a name of a department within a retail space), among other possibilities. Further, the indication of the particular location may be received in the form of anonymized data streams. That is, primary-sensor data representing information related to people located within the physical space may represent people as discrete entities. In this manner, the sensor data may not provide any information related to an individual identity of a person, thereby maintaining privacy of the individual. In any case, once received, the indication of the particular location may be stored in data storage (e.g., data storage 108) and/or processed (e.g., using processors 106) to provide the functionality further discussed below.

Continuing at block 304, the computing system also receives from a subset of secondary sensors a first pattern of outputs (alternatively referred to herein as a “feature”) estimating the location of the subject. In one implementation, the first pattern of outputs is comprised of individual outputs from each secondary sensor in the subset of secondary sensors. In some implementations, each individual secondary-sensor output may be in the form of computer-readable data packets specifying estimated coordinates of an estimated location of the subject. In some examples, these coordinates may be framed from an arbitrary point of reference, such as the center of the physical space or one corner of the physical space. In other examples, the estimated location may be in the form of an address, and/or a list of characters representing a name (e.g., a name of a department within a retail space), among other possibilities. As was the case with the primary-sensor data, pattern of secondary-sensor outputs may be received in the form of anonymized data streams. That is, secondary-sensor data representing information related to people located within the physical space may represent people as discrete entities. In this manner, the sensor data may not provide any information related to an individual identity of a person, thereby maintaining privacy of the individual.

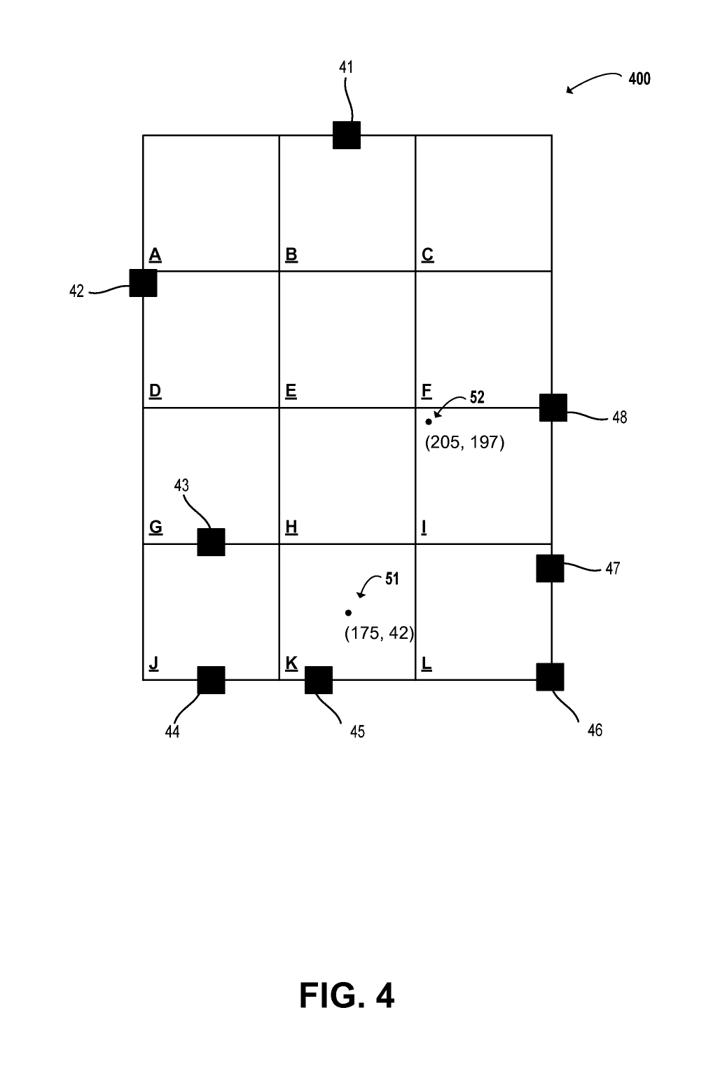

In some implementations of the method, in order to facilitate the sensor boosting technique the computing system generates a representation of the physical space and divides the representation into sectors. For conceptual purposes, FIG. 4 depicts an example representation of a physical space 400, which may be representative of physical space 100A or 200. Physical space 400 is shown as being divided into 12 sectors A-L (referred to herein as 12-sector granularity); however, in other examples (as will be discussed), a physical space may be configured with more or less granularity and accordingly divided into more or fewer sectors being any size or shape. In still other examples, the representation of the physical space is not divided into sectors at all, and sensor data received may refer to a point location in the physical space. Other examples are possible as well.

Also depicted in FIG. 4 are example locations of primary and secondary sensors. As depicted, a primary sensor 41 may be provided, and secondary sensors 42-48 may also be provided. In other examples, more or fewer primary and secondary sensors may be provided, and such sensors may be positioned in in the same or different locations as depicted in FIG. 4.

By way of example and in accordance with block 302, the computing system may receive from the primary sensor 41 an indication that a subject is located at position 51. In one implementation, the indication received from the primary sensor may contain data specifying the location as sector K. In an alternative implementation, the indication may contain raw coordinate data, such as the example coordinates (175, 42). In this case, the computing system may refer to a sector map or other data to resolve the raw coordinate data as being indicative of sector K. The computing system may receive the data in other forms as well.

By way of further example and in accordance with block 304, the computing system may also receive a first pattern of outputs from a subset of secondary sensors, say secondary sensors 43, 44, and 45. The pattern of outputs received from the secondary sensors may include respective estimated locations of the subject. In one implementation, the pattern of outputs received from the secondary sensors may contain data specifying a sector or sectors in which the subject is estimated to be located. In an alternative implementation, the pattern of outputs may contain raw coordinate data, such as a set of example coordinates (185, 210), (110, 41), and (94, 15). In this case, the computing system may refer to the sector map or other data to resolve the set of raw coordinates and the first pattern as being indicative of sectors H, K and J, respectively. Thus, H, K, J may constitute the first pattern of outputs. For illustration purposes, Table 1 contains a listing of the primary and secondary sensor data received in accordance with the above-described example.

TABLE 1

| | | Sector |
|---|---|---|
| Sensor | Raw Data | (12-Sector Granularity) |
| Primary (41) | (175, 42) | K |
| Secondary (43) | (185, 210) | H |
| Secondary (44) | (110, 41) | K |
| Secondary (45) | (94, 15) | J |

For further illustration purposes, Table 2 contains a listing of primary and secondary sensor data that maybe received in accordance with another example iteration of blocks 302 and 304. In particular, the computing system may receive from the primary sensor 41 an indication that a subject is located at position 52. In one implementation, the indication received from the primary sensor may contain data specifying the location as sector I. In an alternative implementation, the indication may contain raw coordinate data, such as the example coordinates (205, 197). In this case, the computing system may refer to a sector map or other data to resolve the raw coordinate data as being indicative of sector I. The computing system may receive the data in other forms as well.

Continuing with this example and in accordance with block 304, the computing system may also receive a first pattern of outputs from a subset of secondary sensors, which in this example may be, say, secondary sensors 42, 47, and 48. The pattern of outputs received from the secondary sensors may include respective estimated locations of the subject. In one implementation, the pattern of outputs received from the secondary sensors may contain data specifying a sector or sectors in which the subject is estimated to be located. In an alternative implementation, the pattern of outputs may contain raw coordinate data, such as a set of example coordinates (180, 205), (151, 179), and (245, 180). In this case, the computing system may refer to the sector map or other data to resolve the set of raw coordinates and the first pattern as being indicative of sectors E, H and I, respectively. Thus, E, H, I may constitute the first pattern of outputs for this example.

TABLE 2

| | | Sector |
|---|---|---|
| Sensor | Raw Data | (12-Sector Granularity) |
| Primary (41) | (205, 197) | I |
| Secondary (42) | (180, 205) | E |
| Secondary (47) | (151, 179) | H |
| Secondary (48) | (245, 180) | I |

Continuing with method 300, at block 306 the computing system resolves the first pattern of outputs as being indicative of the particular location. For instance, upon collecting data such as that listed in Table 1 and/or Table 2, the computing system may store in data storage an indication that the first pattern of outputs (received from the secondary sensors) is indicative of the particular location (received from the primary sensor). This is referred to as producing a label. For instance, Table 3 contains data entries representing the pattern of outputs described above with respect to Table 1 and Table 2. More specifically, Table 3 contains an entry based on the data from Table 1, which indicates that when (i) sensor 43 indicates a subject is located somewhere in sector H, (ii) sensor 44 indicates a subject is located somewhere in sector K, and (iii) sensor 45 indicates a subject is located somewhere in sector J, collectively this pattern indicates that a subject is actually in sector K. Thus, this pattern may be labeled as being indicative of location K.

Similarly, Table 3 contains an entry based on the data from Table 2, which indicates that when (i) sensor 42 indicates a subject is located somewhere in sector E, (ii) sensor 47 indicates a subject is located somewhere in sector H, and (iii) sensor 48 indicates a subject is located somewhere in sector I, collectively this pattern indicates that a subject is actually in sector I. Thus, this pattern may be labeled as being indicative of location I. The computing system may engage in the functionality of blocks 302, 304, and 306 a number of additional times in order to generate additional entries in Table 3 and thereby increase the accuracy with which the computing system resolves potential locations of subjects in the physical space.

TABLE 3

| | | | | Subject Location |
|---|---|---|---|---|
| | | | | (12-Sector |
| Sensor Pattern | Sensor Pattern | Sensor Pattern | . . . | Granularity) |
| 43 → H | 44 → K | 45 → J | . | K |
| 42 → E | 47 → H | 48 → I | . | I |
| . | . | . | . | . |
| . | . | . | . | . |
| . | . | . | . | . |

Continuing at block 308, the computing system receives from the secondary sensors a second pattern of outputs that estimate the locations of a new subject. Again, in one implementation, the pattern of outputs received from the secondary sensors may contain data specifying a sector or sectors in which the new subject is estimated to be located. In an alternative implementation, the pattern of outputs may contain raw coordinate data, such as a set of example coordinates representing estimated locations of the new subject.

By way of example, the computing system may receive from secondary sensor 43 coordinate data that estimates the new subject as being located in sector H, from secondary sensor 44 coordinate data that estimates the new subject as being located in sector K, and from secondary sensor 45 coordinate data that estimates the new subject as being located in sector J. Thus, an indication of sectors H, K, J from sensors 43, 44, 45, respectively, may constitute the second pattern of outputs. In other examples, a second pattern of outputs may comprise data from more or fewer secondary sensors.

Continuing at block 310, the computing system identifies a match between the second pattern of outputs and the first pattern of outputs. For instance, upon receiving the second pattern of outputs, the computing system may refer to data storage and query a set of matched patterns such as that described by way of example with reference to Table 3. By way of example, the computing system may query Table 3 for the matched pattern H, K, J from sensors 43, 44, 45, respectively, and discover that this matched pattern is indicative of a subject being located in sector K. As just described, in some implementations, the computing device matches the second pattern of outputs by identifying the entire second pattern in the set of matched patterns (i.e., that the set of matched patterns includes the pattern H, K, J from sensors 43, 44, 45, respectively). However, in an alternate implementation, the computing device matches the second pattern of outputs by identifying the second pattern in just a portion of a larger pattern. For instance, the set of matched patterns may include a pattern that has additional sensor indications (e.g., sensor indications from, say, secondary sensors 42 and 46) in addition to sensor indications H, K, J from sensors 43, 44, 45, respectively). In this implementation, the computing device would still identify this pattern as being a match with the second pattern because it contains the second pattern. Other ways to match the second pattern are possible as well.

As a result of matching the second pattern of outputs to the first pattern of outputs, the method 300 may continue at block 312 where the computing device determines the location of the new subject to be the particular location identified by matching the second pattern to the first pattern, which in the example described above is sector K. Other examples of matching a second pattern of outputs are possible as well.

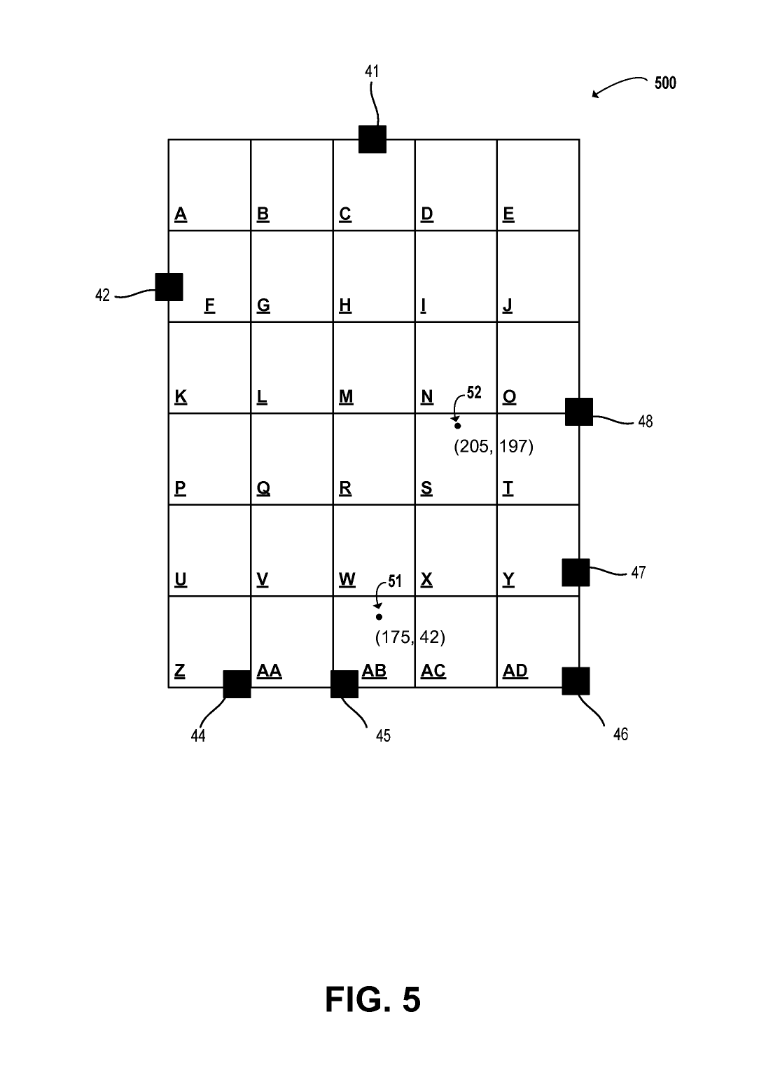

Although not depicted in the flowchart of FIG. 3, the computing system may engage in one or more additional operations. For instance, in some implementations of the method, the computing system determines that it has generated a sufficient number of patterns (e.g., in Table 3) such that the sector granularity of the representation of the physical space may be increased. Increasing the granularity may enable the computing system to resolve locations of subjects with increased accuracy. FIG. 5 depicts an example representation of a physical space 500, which is similar to physical space 400 and may be representative of physical space 100A or 200. Physical space 500 is shown as being divided into 30 sectors A-AD (referred to herein as 30-sector granularity), instead of being divided into 12 sectors as was physical space 400. As shown, increasing the granularity of a physical space decreases the size of each sector, which decreases the physical area in which a subject is estimated to be located, thereby increasing the accuracy of location estimation. In accordance with one example of increasing the granularity of a physical space, the computing system may adjust any previously stored data to reflect the new sector designations.

In some implementations of the method, the computing system generates a heat map of the physical space based on a compilation of all sensor patterns collected. The heat map may represent areas of the physical space that have many unique patterns of sensor data that are indicative of subjects being located in those areas. In one example, the computing system may generate the heat map based on a Gaussian distribution of all collected sensor patterns. However, in other examples, the computing system may generate a heat map in other ways as well.

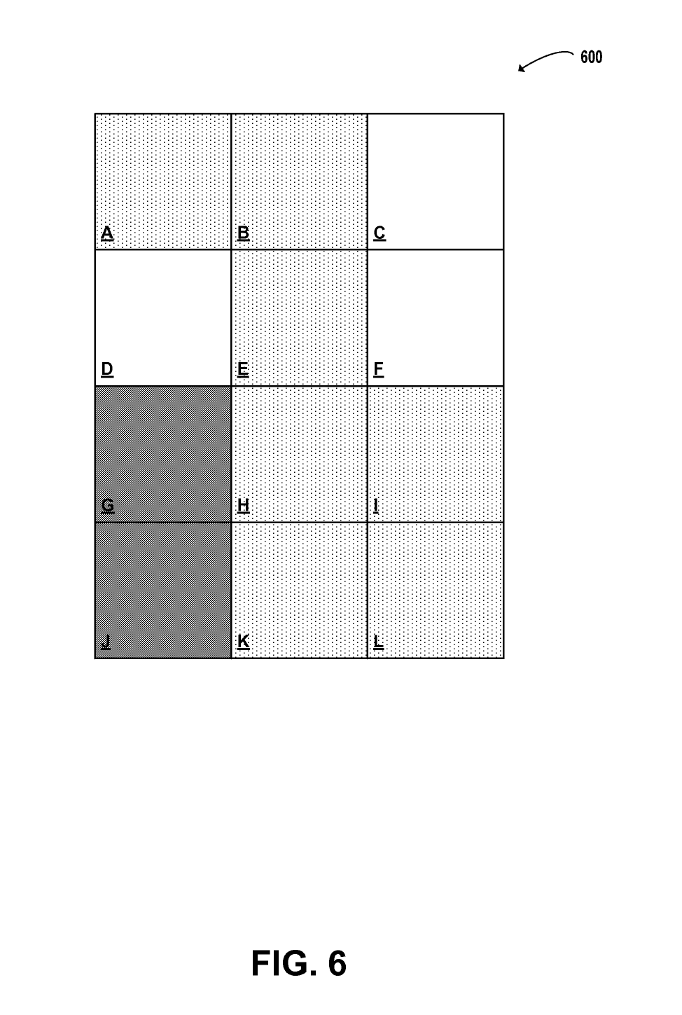

FIG. 6 depicts an example heat map 600 that may be generated based on the collected sensor patterns. In the example depicted in FIG. 6, sectors G and J are relatively dark, whereas sectors A, B, E, H, I, K, and L are medium-dark, and sectors C, D, and F are relatively light. First, this may indicate that there are relatively many different types of secondary sensor patterns that are indicative of a subject being located in either sector G or J. Thus, the computing system is able to relatively accurately determine when a subject is located in sectors G or J based on resolving secondary sensor output patterns. Second, the heat map may indicate that there are relatively few types of secondary sensor patterns that are indicative of a subject being located in any of sectors C, D, and F. Thus, the computing system may not be able to accurately determine when a subject is located in sectors C, D, F based on resolving secondary sensor output patterns.

In some examples, heat map 600 is provided to a system operator who may analyze the heat map to make decisions about the physical space. For instance, based on heat map 600, the operator may determine to provision additional sensors at or near sectors C, D, and F in order to increase the accuracy of detecting subject locations in those sectors. Additionally or alternatively, the operator may decide to move any sensors at or near sectors G or J as they may not be providing any additional benefit to those sectors. And still additionally or alternatively, the operator may determine to place merchandise near high-accuracy areas (e.g., sectors G and J) because the computing system may more accurately determine when subjects are near the merchandise. Other determinations may be made based on heat maps as well.

Turning now to FIG. 7, a second method 700 is provided. Method 700 begins at block 702 where the computing system receives from a primary sensor (e.g., sensors 101A) positioned in a physical space (e.g., physical space 100A) an indication of a particular location of a subject. Consistent with the examples described above with respect to method 300, the indication of the particular location of the subject may be received in the form of data packets specifying coordinates of the particular location. As explained, these coordinates may be framed from an arbitrary point of reference, such as the center of the physical space or one corner of the physical space. In other examples, the particular location may be in the form of an address, and/or a list of characters representing a name (e.g., a name of a department within a retail space), among other possibilities. Further, the indication of the particular location may be received in the form of anonymized data streams. That is, primary-sensor data representing information related to people located within the physical space may represent people as discrete entities. In this manner, the sensor data may not provide any information related to an individual identity of a person, thereby maintaining privacy of the individual. In any case, once received, the indication of the particular location may be stored in data storage (e.g., data storage 108) and/or processed (e.g., using processors 106) to provide the functionality further discussed below.

Continuing at block 704, at about the same time the computing system receives from the primary sensor an indication of the particular location of the subject in accordance with block 302, the computing system also receives from a secondary sensor an estimated location of the subject. Consistent with the examples described above with respect to method 300, the estimated location may be received by the computing system in the form of computer-readable data packets specifying estimated coordinates of an estimated location of the subject. As explained, these coordinates may be framed from an arbitrary point of reference, such as the center of the physical space or one corner of the physical space. In other examples, the estimated location may be in the form of an address, and/or a list of characters representing a name (e.g., a name of a department within a retail space), among other possibilities. As is the case with the primary-sensor data, the estimated location data received from the secondary sensor may be received in the form of anonymized data streams. That is, secondary-sensor data representing information related to people located within the physical space may represent people as discrete entities. In this manner, the sensor data may not provide any information related to an individual identity of a person, thereby maintaining privacy of the individual.

Continuing at block 706, the computing system compares the estimated location received from the secondary sensor to the particular location received from the primary sensor and based on this comparison assign a confidence level to the secondary sensor for the estimated location. In some examples, the computing system may assign a confidence level to the secondary sensor based on how close the secondary sensor's estimated location of the subject is to the particular location of the subject received by the primary sensor. The confidence level may be a percentage from 0% to 100%, with 0% representing an estimated location that is as far as possible in the physical space from the primary sensor's indicated location, and 100% representing an estimated location that is about the same location as indicated by the primary sensor. Alternatively, the confidence level may be a simpler rating, perhaps on a scale of 1-5, but still assigned based on how close the secondary sensor's estimated location is to the location indicated by the primary sensor. Once assigned, the computing system may store the confidence rating in data storage, along with an indication of the secondary sensor and the estimated location to which the confidence level applies for the secondary sensor. Further, the computing system may engage in the functionality of blocks 702, 704, and 706 a number of additional times in order to generate additional confidence levels for the secondary sensor at other estimated locations, as well as to generate confidence levels for other secondary sensors positioned about the physical space for a variety of estimated locations.

Continuing at block 708, the computing system receives from two or more secondary sensors conflicting indications of estimated locations of a new subject. For instance, referring back to FIG. 4, secondary sensor 48 may indicate that a given subject is located at position 52 in sector I, whereas secondary sensor 46 may indicate that the given subject is located at position 51 in sector K. These indications are in conflict, and as a result, the flow proceeds to block 710 where the computing system identifies confidence levels of the secondary sensors for each estimated location. For instance, the computing system may refer to data storage and determine that sensor 48 has a confidence level of 80% when indicating an estimated location in sector I, and sensor 46 has a confidence level of 40% when indicating an estimated location in sector K. These are merely examples and other confidence levels are possible as well.

Continuing at block 712, the computing system determines the location of the new subject based on the identified confidence levels. In accordance with one implementation, the computing system determines the location of the new subject to be the location indicated by the sensor with the highest confidence level. In the example set forth above, the computing system may determine the new subject's location to be sector I because 80% is larger than 40%. In an alternative implementation, the computing system determines the location of the new subject based on a weighted combination of the secondary sensors' estimated locations. For instance, the computing system may apply a zone surrounding each secondary sensor's estimated location, where the size of the zone is inversely proportional to the confidence level of that secondary sensor for the estimated location (i.e., a confidence level of 80% may have a relatively small zone surrounding the estimated location, whereas a confidence level of 40% may have a relatively larger zone surrounding the estimated location). Upon application of the zones, the computing system may determine whether any part of the zones intersect or overlap, and if so, the computing system may determine the location of the new subject to be within the overlapping area of the zones. In the example set forth above, such an overlap may occur in sector H, and as such, the computing system may determine the location of the new subject to be in sector H. However, this is just one example of applying a weighted combination of confidence levels, and other ways are possible as well.

Although not depicted in the flowchart of FIG. 7 the computing system may engage in one or more additional operations. For instance, in some implementations of the method, the computing system generates a heat map of the physical space based on an aggregate of all assigned confidence levels. Similar to the description of the heat map with respect to FIG. 6, the heat map may represent indications of confidence levels assigned to a secondary sensors for each location in the heat map. In one example, the computing system may generate the heat map based on a Gaussian distribution of all assigned confidence levels. However, in other examples, the computing system may generate a heat map in other ways as well.

Using the heat map 600 of FIG. 6 as an example, because sectors G and J are relatively dark, this may indicate that there is at least one relatively-high confidence level (e.g., a confidence level above a threshold of, say, 90%) assigned to at least one secondary sensor for sectors G and J. Additionally, because sectors C, D, and F, are relatively light, this may indicate that there are not any confidence levels that are at or above at least a threshold level (e.g., 50%) assigned to any secondary sensors for these sectors. Thus in this example, the computing system is able to relatively accurately determine when a subject is located in sectors G or J based on reference to assigned confidence levels. Further, the computing system may not be able to accurately determine when a subject is located in sectors C, D, F based on reference to assigned confidence levels. Other inferences may be drawn based on the heat map.

### IV. Conclusion

The present disclosure is not to be limited in terms of the particular implementations described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims.

The above detailed description describes various features and functions of the disclosed systems, devices, and methods with reference to the accompanying figures. In the figures, similar symbols typically identify similar components, unless context dictates otherwise. The example implementations described herein and in the figures are not meant to be limiting. Other implementations can be utilized, and other changes can be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

The particular arrangements shown in the figures should not be viewed as limiting. It should be understood that other implementations can include more or less of each element shown in a given figure. Further, some of the illustrated elements can be combined or omitted. Yet further, an example implementation can include elements that are not illustrated in the figures.

While various aspects and implementations have been disclosed herein, other aspects and implementations will be apparent to those skilled in the art. The various aspects and implementations disclosed herein are for purposes of illustration and are not intended to be limiting, with the true scope being indicated by the following claims.

In situations in which the systems discussed here collect personal information about users, or may make use of personal information, the users may be provided with an opportunity to control whether programs or features collect user information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by a content server.

1. A method comprising:
based on primary sensor data received from a primary sensor, determining that a subject is located in a first sector of a plurality of sectors of an environment;
based on initial secondary sensor data received from a plurality of secondary sensors, determining a first pattern comprising an initial respective sector of the plurality of sectors in which each of the plurality of secondary sensors detected the subject;
storing in a data storage an indication that the first pattern is indicative of the first sector;
based on subsequent secondary sensor data received from the plurality of secondary sensors, determining a second pattern comprising a subsequent respective sector of the plurality of sectors in which each of the plurality of secondary sensors detected a new subject;
identifying a match between the second pattern and the first pattern wherein identifying the match comprises determining that the first pattern includes each subsequent respective sector of the second pattern; and
based on (i) identifying the match between the second pattern and the first pattern, and (ii) the stored indication, determining that the new subject is located in the first sector.

2. (canceled)

3. (canceled)

4. The method of claim 1, wherein the initial secondary sensor data comprises a respective set of coordinates from each of the plurality of secondary sensors, wherein each respective set of coordinates is located in one of the initial respective sectors, and wherein determining the first pattern comprises:
resolving each respective set of coordinates to one of the initial respective sectors; and
generating the first pattern based on the initial respective sector of each respective set of coordinates.

5. (canceled)

6. The method of claim 1, further comprising:
generating a heat map representative of the environment, wherein the heat map indicates a number of patterns that map to each sector of the plurality of sectors.

7-13. (canceled)

14. A system comprising:
a primary sensor temporarily provided in an environment;
a plurality of secondary sensors fixed in the environment;
one or more processors;
a communication interface; and
computer-readable storage media having stored thereon instructions that, when executed by the one or more processors, cause the system to engage in operations, the operations comprising:
based on initial primary sensor data received from the primary sensor, determining that a subject is located in a first sector of a plurality of sectors of the environment;
based on initial secondary sensor data received from the plurality of secondary sensors, determining a first pattern comprising an initial respective sector of the plurality of sectors in which each of the plurality of secondary sensors detected the subject, wherein the initial secondary sensor data is received while the primary sensor is provided in the environment;
storing in a data storage an indication that the first pattern is indicative of the first sector;
based on subsequent secondary sensor data received from the plurality of secondary sensors, determining a second pattern comprising a subsequent respective sector of the plurality of sectors in which each of the plurality of secondary sensors detected a new subject, wherein the subsequent secondary sensor data is received after the primary sensor has been removed from the environment;
identifying a match between the second pattern and the first pattern, wherein identifying the match comprises determining that the first pattern includes the subsequent respective sectors of the second pattern; and
based on (i) identifying the match between the second pattern and the first pattern, and (ii) the stored indication, determining that the new subject is located in the first sector.

15. The system of claim 14, the initial secondary sensor data comprises a respective set of coordinates from each of the plurality of secondary sensors, wherein each respective set of coordinates is located in one of the respective sectors in the environment, and wherein the operations further comprise:
resolving each respective set of coordinates to the respective sector in which the respective set of coordinates is located; and
generating the first pattern based on the respective sector of each respective set of coordinates.

16. The system of claim 14, wherein the initial primary sensor data comprises a set of coordinates located in the first sector.

17. The system of claim 14, wherein the operations further comprise:
based on subsequent primary sensor data received from the primary sensor, determining that a third subject is located in a second sector;
for each given secondary sensor of the plurality of secondary sensors:
(a) receiving, from the given secondary sensor, additional secondary sensor data,
(b) based on the additional secondary sensor data, determining a sector of the plurality of sectors in which the given secondary sensor detected the third subject, and
(c) assigning a respective confidence level to the given secondary sensor for the determined sector, wherein the respective confidence level is based on how close the determined sector is to the first sector;
based on further secondary sensor data received from the plurality of secondary sensors, determining conflicting respective sectors in which each of the plurality of secondary sensors detected a fourth subject, wherein the conflicting respective sectors are different sectors; and
based on (i) the respective confidence level of each of the plurality of secondary sensors, and (ii) the conflicting respective sectors in which each of the plurality of secondary sensors detected the fourth subject, determining a location of the fourth subject.

18. The system of claim 17, wherein the confidence level assigned to the given secondary sensor is based on a respective proximity of the sector of the plurality of sectors in which the given secondary sensor detected the third subject to the second sector.

19. The system of claim 17, wherein determining a location of the fourth subject comprises:
determining a location of the fourth subject to be a sector indicated by a secondary sensor having a highest respective confidence level.

20. The system of claim 17, wherein determining a location of the fourth subject comprises:
determining a location of the fourth subject to be a location based on a weighted combination of the conflicting respective sectors, with each individual sector being weighted in accordance with a confidence level assigned to a corresponding secondary sensor for the individual sector.

21. The method of claim 1, wherein the primary sensor is provisioned in the environment when the initial secondary sensor data is received from the secondary sensors, and wherein the primary sensor has been removed from the environment when the initial subsequent secondary sensor data is received from the secondary sensors.

22. The method of claim 1, wherein the secondary sensors are fixed in the environment.

23. The method of claim 1, wherein the primary sensor data comprises a set of coordinates located in the first sector.

24. The method of claim 1, wherein the primary sensor data comprises a set of coordinates located in the first sector.

25. A non-transitory computer-readable storage media having stored thereon instructions that, when executed by one or more processors, cause the system to engage in operations, the operations comprising:
based on primary sensor data received from a primary sensor, determining that a subject is located in a first sector of a plurality of sectors of an environment;
based on initial secondary sensor data received from a plurality of secondary sensors, determining a first pattern comprising an initial respective sector of the plurality of sectors in which each of the plurality of secondary sensors detected the subject;
storing in a data storage an indication that the first pattern is indicative of the first sector;
based on subsequent secondary sensor data received from the plurality of secondary sensors, determining a second pattern comprising a subsequent respective sector of the plurality of sectors in which each of the plurality of secondary sensors detected a new subject;
identifying a match between the second pattern and the first pattern, wherein identifying the match comprises determining that the first pattern includes each subsequent respective sector of the second pattern; and
based on (i) identifying the match between the second pattern and the first pattern, and (ii) the stored indication, determining that the new subject is located in the first sector.

26. The computer-readable storage medium of claim 25, wherein the initial secondary sensor data comprises a respective set of coordinates from each of the plurality of secondary sensors, wherein each respective set of coordinates is located in one of the initial respective sectors, and wherein determining the first pattern comprises:
resolving each respective set of coordinates to one of the initial respective sectors; and
generating the first pattern based on the initial respective sector of each respective set of coordinates.
